(19) United States
(12) Patent Application Publication
(10) Pub. No.: US 2005/0021665 A1
(43) Pub. Date: Jan. 27, 2005

(54) Content delivery server, terminal, and program

(76) Inventors: Nobuhiro Sekimoto, Kokubunji (JP); Haru Ando, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/638,399

(22) Filed: Aug. 12, 2003

(30) Foreign Application Priority Data
May 26, 2003 (JP) 2003-147747

(51) Int. Cl. G06F 15/16

(52) U.S. Cl. 709/217; 715/865

(57) ABSTRACT

A content is delivered in consideration of a terminal used by a user, an ambient environment of the user and the terminal, and the characteristics and preferences of the user. A content delivery server has an input/output unit for transmitting and receiving information between itself and a terminal, a content management unit for managing contents composed of modalities, and a control unit for controlling the input/output unit and the content management unit. The control unit obtains attribute information composed of terminal attribute information on an output interface at the terminal, environmental attribute information on the current ambient environment of the terminal, and user attribute information on the characteristics of the user, generates, based on the obtained attribute information, modality construction information for specifying the modalities of a content to be delivered to the terminal, determines, by using the modality construction information, a modality construction for the content to be delivered which is under the management of the content management unit, and delivers the content composed of the determined modalitis to the terminal via the input/output unit.

### BACKGROUND OF THE INVENTION

1. Field of the Invention

The present invention relates to a delivery server and a user terminal each used in a content delivery service which appropriately changes a content in response to the performance and function of the terminal used by a user, to the situation in which the terminal is placed, and to a situation of use composed of the characteristics of the user.

2. Description of Related Art

Examples of conventional content delivery service capable of responding to the situation in which the service is used by the user include the following ones.

In the example disclosed in JP-A No. 202000/2001 (Patent Document 1), a user preliminarily registers the schedule of his or her actions, the relationship between the attributes of a plurality of contents possessed by a server and the attributes of the actions as well as the relations among the contents are evaluated, and the order in which the plurality of contents are delivered is determined to maximize the effect of leading the user to understand the contents, particularly educational contents, and the contents are delivered sequentially to the terminal with the lapse of time.

In the example disclosed in JP-A No. 271383/2002 (Patent Document 2), contents are delivered while a content delivery method and the qualities of the contents are changed in response to a communication environment providing a connection between a server and a terminal and to reproduction software operating at the terminal.

In the example disclosed in JP-A No. 183031/2002 (Patent Document 3), a sample A is provided along with examples B and C of the mode for displaying the sample upon user identification. If the user at the terminal selects any among the examples of the display mode, information on the viewing environment of the user is detected based on the result of selection so that the provider of the contents selects among the patterned display modes and delivers the contents.

On the other hand, the example disclosed in JP-A No. 269141/2002 (Patent Document 4) proposes a server which compiles contents such that the contents are suited to environmental conditions under which clients view and/or hear the contents and provides the compiled contents to the client. In this example, the server compiles the contents in accordance with the environmental conditions of the clients that have been preliminarily extracted and delivers the compiled contents.
[Patent Document 1]
JP-A No. 202000/2001
[Patent Document 2]
JP-A No. 271383/2002
[Patent Document 3]
JP-A No. 183031/2002
[Patent Document 4]
[JP-A No. 269141/2002]

According to the foregoing prior art technology, however, the actions (or environments) of the user should be inputted in advance and if the user performs an unscheduled action by changing his or her plan, contents which are not suited to the situation are delivered or the user should input again re-scheduled actions and environments.

In addition, the foregoing conventional examples have not mentioned the characteristics of the users and adaptation to the ambient situations in which terminals are placed. Therefore, it has conventionally been a challenge to generally judge the characteristics and preferences of the users, the types and performance of the terminals, and the environments in which the users and the terminals are placed and deliver and present contents having appropriate modalities (means for presenting or expressing information to the users).

### SUMMARY OF THE INVENTION

It is therefore an object of the present invention to deliver a content provided with a modality suited to the abilities and preferences of the user and appropriate for the terminal used by the user, the time of day, and the location such that the user is allowed to view and/or hear the content in an individually effective mode whenever and wherever he or she wants to do so.

Accordingly, the present invention allows a content delivery server to select and deliver a content composed of modalities considering the terminal used by the user, the ambient environment including the relationship between the user and the terminal, and the characteristics and preferences of the user and allows the user to view and/or hear an arbitrary content composed of optimum modalities suited to the environment even if he or she changes the location, the time, or the terminal.

In addition, the content delivery server is also allowed to deliver minimum required data to the terminal. By preventing the delivery of modalities that cannot be used at the terminal, as has been performed in the conventional examples, a burden on the server and communication equipment can be reduced.

A server according to the present invention comprises: an input/output unit for performing transmission and reception of information between itself and a terminal connected thereto; a content management unit for managing a content composed of at least one or more modalities; and a control unit for controlling the input/output unit and the content management unit, wherein the control unit obtains, of attribute information composed of terminal attribute information on an output interface at the terminal, environment attribute information on a current ambient environment of the terminal, and user attribute information on a characteristic of a user using the content by means of the terminal, at least two sets of the attribute information via the input/output unit, generates, based on the obtained attribute information sets, modality construction information specifying modalities to be delivered to the terminal, determines, by using the modality construction information, a modality construction for the content to be delivered which is under the management of the content management unit, and delivers the content composed of the determined modalities to the terminal via the input/output unit, so that the modalities suited to the environment and location of the terminal and to the situation of the user using the terminal are delivered.

### BRIEF DESCRIPTION OF THE DRAWINGS

FIG. 1 is a structural view of a system according to an embodiment of the present invention;

FIG. 2 is a view illustrating a typical conventional example of content delivery;

FIG. 3 is a view illustrating an example of display (involving only sound modal) according to the present invention;

FIG. 4 is a view illustrating an example of display (involving only video modal) according to the present invention;

FIG. 5 is a view illustrating user attribute information;

FIG. 6 is a view illustrating terminal attribute information;

FIG. 7 is a view illustrating environment attribute information;

FIG. 8 is a view illustrating an attribute relation chart;

FIG. 9 is a flow chart of operations at a content delivery server and a terminal;

FIG. 10 is a detailed flow chart of a terminal attribute obtaining step;

FIG. 11 is a detailed flow chart of an environment attribute obtaining step;

FIG. 12 is a detailed flow chart of a user attribute obtaining step;

FIG. 13 is a view illustrating a GUI for obtaining user attribute information;

FIG. 14 is a detailed flow chart of a modality construction information producing step;

FIG. 15 is a view illustrating modality construction information;

FIG. 16 is a detailed flow chart of a content selecting step;

FIG. 17 is a view illustrating a basic content;

FIG. 18 is a view (selective) illustrating a delivered content;

FIG. 19 is a detailed flow chart of a converting step for a modality to be delivered;

FIG. 20 is a view illustrating a basic content;

FIG. 21 is a view illustrating a design drawing for converting a basic content;

FIG. 22 is a view illustrating a content to be delivered;

FIG. 23 is a view illustrating a system for performing process steps at a terminal;

FIG. 24 is flow chart of operations at a server and a terminal in a third example; and

FIG. 25 is a detailed flow chart of a converting step for a modality to be delivered.

### DETAILED DESCRIPTION OF THE PREFERRED EMBODIMENTS

Referring to the accompanying drawings, an embodiment of the present invention will be described herein below.

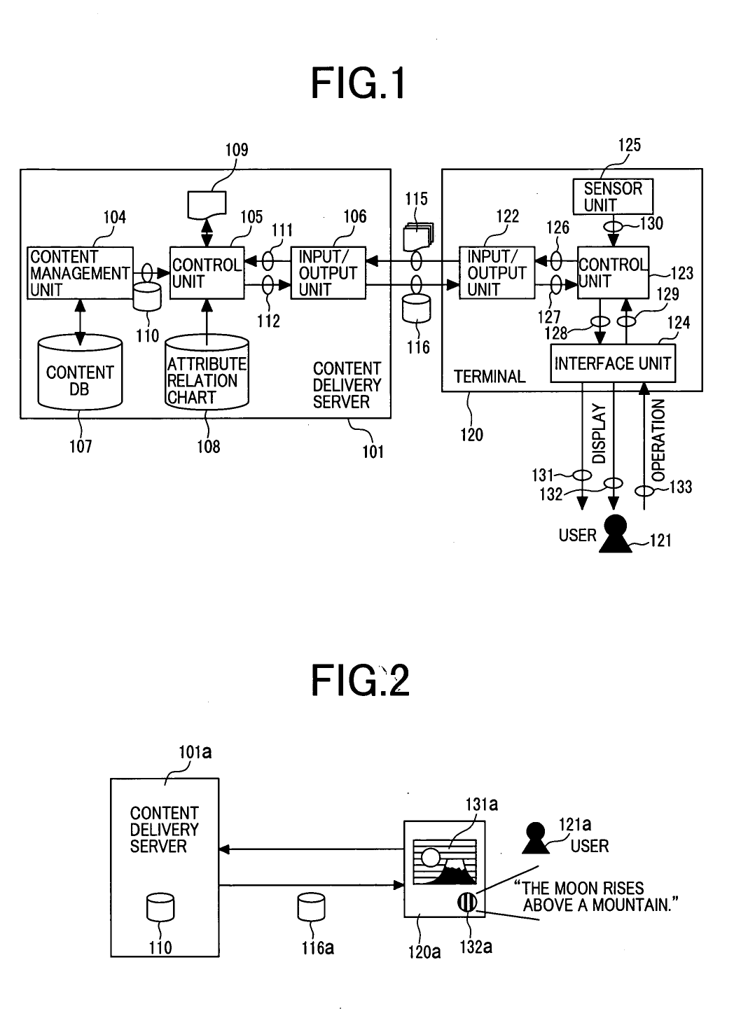

FIG. 1 is a structural view of a system according to the present invention. A content delivery server 101 is primarily constituted by: a control unit 105 located at the center; a content management unit 104 for managing contents; and an input/output unit 106 for performing communication with a terminal 120.

There is also a content DB (database) 107 for holding the contents managed by the content management unit 104, in which basic contents 110 are stored. The control unit 105 has an attribute relation chart 108 used as rules for the reconstruction of a content suited to a terminal, which will be described later, and modality constitution information 109 generated from the attribute relation chart 108.

In the present invention, a modality is defined as means for a human being to interpret information on media which is information presenting means composing a content, such as a voice, music, a sound, a video image, a text, computer graphics, or vector data (map). A content is composed of a modality. For example, a movie content is composed of modalities which are a video image, a voice, and a sound or a text (subtitles).

A terminal 120 can be composed of a personal computer, a PDA (Personal Digital Assistant), a mobile phone, a car navigation system, a display device which can be used apart from the main body (e.g., a smart display), or the like.

The terminal 120 connected to the content delivery server 101 via the network is constituted by: a control unit 123 located at the center; an input/output unit 122 for performing communication with the delivery server; an interface unit 124 for displaying or outputting a content to the user the content; and a sensor unit 125 for sensing the situation of an external environment. The content delivery server 101 is capable of simultaneous connection with a plurality of terminals 120 and operation including communication such as content delivery. The sensor unit 125 can be composed of, e.g., a microphone for measuring noise around the terminal 120, a CCD camera for sensing brightness and darkness around the terminal 120, a GPS or wireless network device for measuring the position of the terminal or a network device for detecting the speed of connection with the network, a mute-mode switch for determining whether or not the user is in a public place, or the like.

A description will be given herein below to the outline of the present invention by using respective examples of display provided to the user in the case of using the conventional service and in the case of using the service according to the present invention, which are shown in FIGS. 2 to 4, and by making a comparison therebetween.

FIG. 2 is a view illustrating a typical conventional example of content delivery. If the typical conventional content delivery is used, a content is delivered through the connection between a content delivery server 101a and a terminal 120a and displayed on a display interface to a user 121. A content 116 sent to the user is the same as a basic content 110 possessed preliminarily by the server.

In this conventional example, a video modality including a dynamic video image is displayed on a video interface 131a or a sound modality including a voice is displayed on a sound interface 132a. In FIG. 2, it is assumed that a video image of the moon rising above a mountain is displayed in the former case or a voice saying “The moon rises above a mountain” is displayed (The present embodiment assumes that the concept of display includes the outputting of a voice or the like. The same shall apply hereinafter.) as a narration in the latter case.

However, information on the presence or absence of the video interface 131a and the sound interface 132a at the terminal 120a has not been sent to the delivery server 101a so that the information is not used for delivery. Even when the video interface 131a does not exist or in the non-functioning state at the terminal 120a, the content delivery server 101a delivers a video modality and a sound modal, either of which will wastefully occupy the band of the network, never to be used.

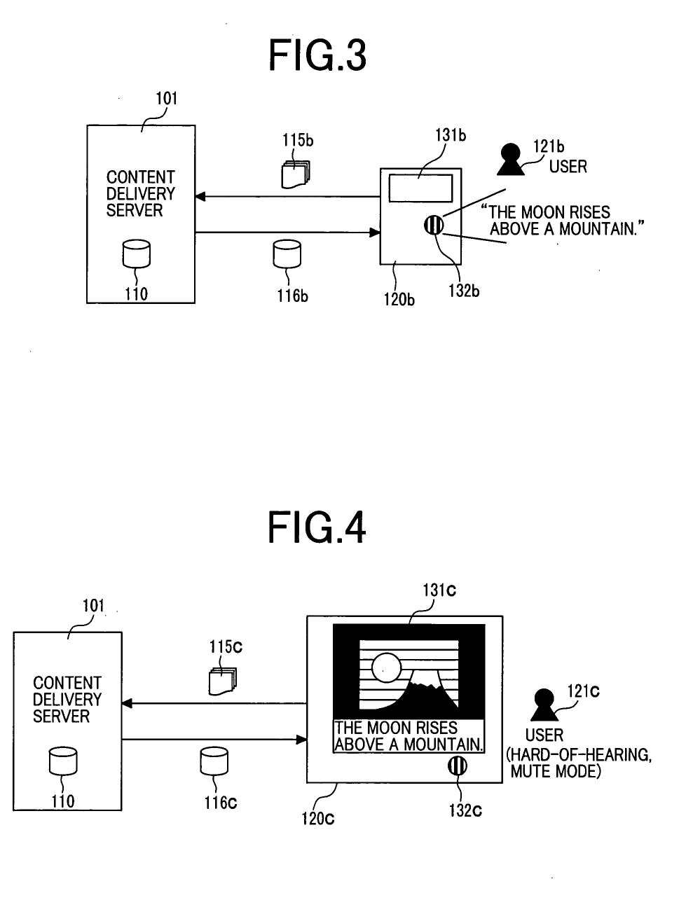

FIG. 3 is a view illustrating an example of the display (using only a voice) according to the present invention. In this example, the sound interface 132b exists at the terminal 120b. It is assumed that the video interface 131b does not exist or, if it exists, the ability thereof is insufficient to display a video image or the user does not need a video image according to his or her preference.

In this case, it is sufficient for only a narration to be displayed to the user 121b, in the same manner as in FIG. 2. In the first place, video data which is relatively large in an amount of data need not be delivered from the server.

According to the present invention, therefore, terminal attribute information on the terminal 120b indicative of the presence or absence of the display interface 131b or the performance thereof (the size of a screen, the number of pixels, the resolution, the number of producible colors, or the like) and user attribute information indicative of the characteristics and preferences of the user 121b are delivered first as attribute information 115b from the terminal 120b to the content delivery server 101 before the reception of a delivered content.

Based on the attribute information 115b, a necessary modality is determined in the content delivery server 101. In this case, only the voice modality is delivered to the terminal 120b. As a result, data on a transmission path between the content delivery server 101 and the terminal 120b is reduced compared with the conventional example shown in FIG. 2 and more efficient content delivery can be performed. This example includes the case where the user 121b cannot visually recognize the video interface 131b because the user 121b is at a distance from the terminal 120b or the terminal 120b is in a bag and away from the user. In such a case, it is preferable for the terminal 120 to give a notice as environment attribute information to the content delivery server 101 such that the same result as described above is obtainable.

FIG. 4 is a view illustrating an example of the display (using only a video image) according to the present invention. In this case, it is assumed that the user 121c has difficulty in hearing sound. The terminal 120c has both the video interface 131c and the sound interface 132c. Even if a content is displayed as a sound to the user 121c, the user needs any assistance since he or she cannot recognize the displayed content. For example, it is necessary to display the voice part of the content delivered from the server as a text.

In general, there is an implicit tendency that the user is allowed to view and hear the basic contents 110 possessed by the content delivery server 101 and the video image and sound thereof are displayable on the terminal except for the case where dedicated delivery service is provided.

According to the present invention, the terminal attribute information, the user attribute information, and the environment attribute information are transmitted as the attribute information 115c from the terminal 120c to the content delivery server 101. The server 101 converts, to a text, modalities originally delivered as a voice or sound and newly delivers the text as a content in the case of this example.

This allows the terminal 120c to display, on the video interface 131c, the text from the content delivery server 101 as a video image and subtitles (also referred to as captions) and provide the text to the user 121c.

It is to be noted that this example also includes the case where the user 121c and the terminal 120c are in a public place such as a streetcar or public facilities and a “mute mode” is set to prevent a sound output, which may be offensive to others, so that all contents are recognized as video image display.

Starting with these two examples, various situations can be considered as examples of the environment in which the user and the terminal are placed, including the relationship therebetween. Accordingly, the content delivery server is desired to be responsive to as many cases as possible.

To respond to the desire, a primary object of the present invention is to enable the content delivery server 101 to obtain the three sets of attribute information, i.e., the user attribute information, the terminal attribute information, and the environment attribute information, make comprehensive consideration, and deliver an appropriate content to the terminal.

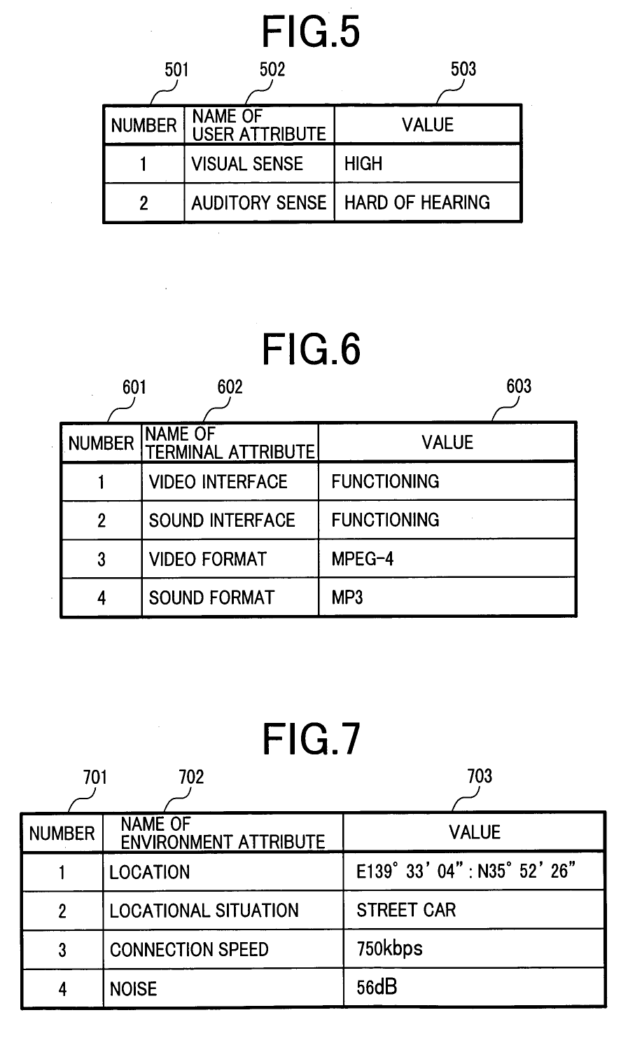

FIG. 5 is a view illustrating an example of the user attribute information. In a table for the user attribute information, numbers 501, the names of user attributes 502, and the values 503 thereof are stored.

In FIG. 5, two items indicative of whether the user is visually and auditorily abled or disabled (the user's visual and auditory abilities) are shown.

FIG. 6 is a view illustrating an example of the terminal attribute information. In a table for the terminal attribute information, numbers 601, the names of terminal attributes 602, and the values 603 thereof are stored. In this example, the presence or absence of the video interface 131 and the sound interface 132 at the terminal 120, the functional features thereof, and data formats that can be decoded are stored in the column of the names of terminal attributes 602 and the column of the values 603 indicates whether or not the individual functional features and the data formats stored in the column of the names of terminal attributes 602 are actually functioning.

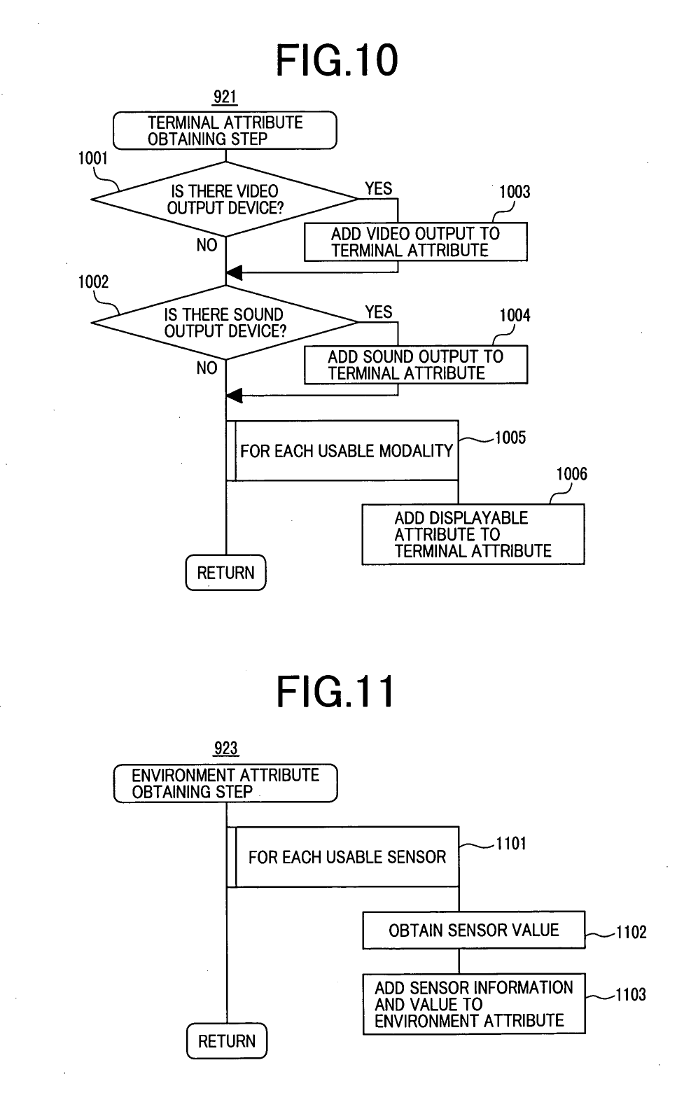

FIG. 10 shows a flow chart of a terminal attribute obtaining step executed at the terminal 120 in the structure shown in FIG. 1, which is for obtaining the terminal attribute information shown in FIG. 6.

First, in Step 1001, the presence or absence of the video interface 131 is determined. If the video interface 131 is present (or functioning), the video interface 131 is added in Step 1003 to the terminal attribute information shown in FIG. 6.

In Step 1002, the presence or absence of the sound interface 132 is determined. If the sound interface 132 is present (or functioning), the sound interface 132 is added in Step 1004 to the terminal attribute information shown in FIG. 6.

Next, in the subroutine of Step 1005, the data format of a modality displayable at the terminal 120 is examined and the data format of a usable modality (or codec) is added in Step 1006 to the terminal attribute information.

By the foregoing step, the terminal attribute information can be obtained. The terminal 120 sends the terminal attribute information to the content delivery server 101.

FIG. 7 is a view illustrating an example of the environment attribute information. In a table for the environment attribute information, numbers 701, the names of environment attributes 702, and the values 703 thereof are stored. For example, the location detected by a GPS (Global Positioning System) as the sensor unit 125 of the terminal 120 is stored in the column of the names of environment attributes 702 and the longitude and latitude representing the detected location are stored in the column of the values 703. Likewise, the mute mode detected based on the operation of the mute mode switch and the locational information detected by the GPS are compared with map data prepared separately at the terminal 120. The locational situation is determined based on the attribute information indicating that, e.g., the user is on a streetcar at the present location and, if the user aboard a streetcar is detected, the locational situation is stored in the column of the names of environment attributes 702 and the streetcar is stored in the column of the values 703. For the communication speed detected by the network device at the terminal 120, which is 750 kbps, the connection speed is stored in the column of the names of environment attributes 702 and 750 kbps is stored in the column of the values 703. For the ambient noise detected by the microphone at the terminal 120, which is 56 dB, noise is stored in the column of the names of environment attributes 702 and 56 dB is stored in the column of the values 703.

Besides, the positional relationship between the terminal 120 and the user 121, the sound characteristic between the terminal 120 and the user 121, the video characteristic between the terminal 120 and the user 121, and the like may also be stored as the environment attribute information.

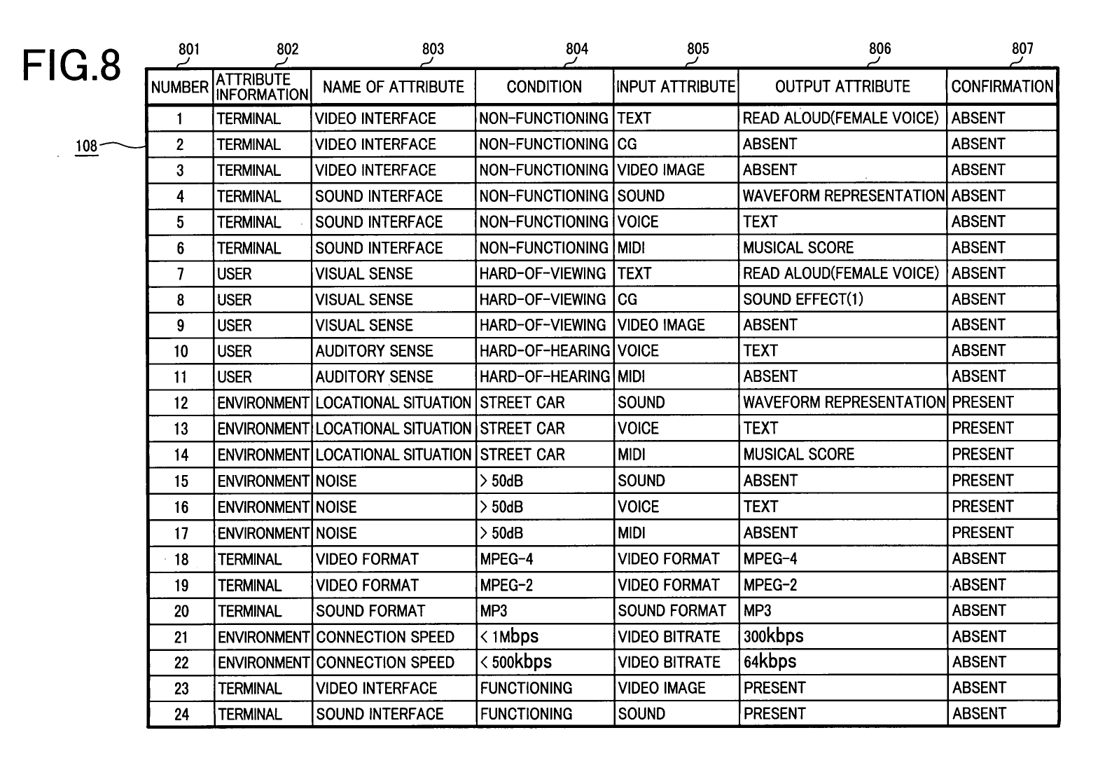

To present conditions for considering the three sets of attribute information shown in FIGS. 5 to 7, the content delivery server 101 in this example has the attribute relation chart 108, as shown in FIG. 1. FIG. 8 is a view illustrating the attribute relation chart 108.

The attribute relation chart 108 has a table composed of the items of a number 801, the name of attribute information (attribute information in the drawing) 802, the name of attribute 803, a condition 804, an input attribute 805, an output attribute 806 and a confirmation 807.

The name of attribute information 802 indicates one of the foregoing three sets of the attribute information (the terminal attribute information, the environment attribute information, and the user attribute information) and the name of attribute indicates one of attributes in the attribute information.

The condition 804 indicates a condition under which the item of concern is validated. The input attribute 805 indicates the attribute of the input modality of a content the delivery of which is scheduled. The output attribute 806 indicates the output attribute (mode) when the input modality is converted or, if no selection is made, “absent” is shown. The confirmation 807 indicates whether or not re-confirmation should be made to the user before a content is displayed, though the content delivery server 101 automatically performs the steps for displaying the content based on the attribute relation chart. The confirmation is made by a method in which the user is inquired of whether or not the content should be converted before it is displayed at the terminal 120 and the user is requested to input an answer. If the user inputs “Yes”, the content is converted and delivered. If the user inputs “No”, the content is not delivered.

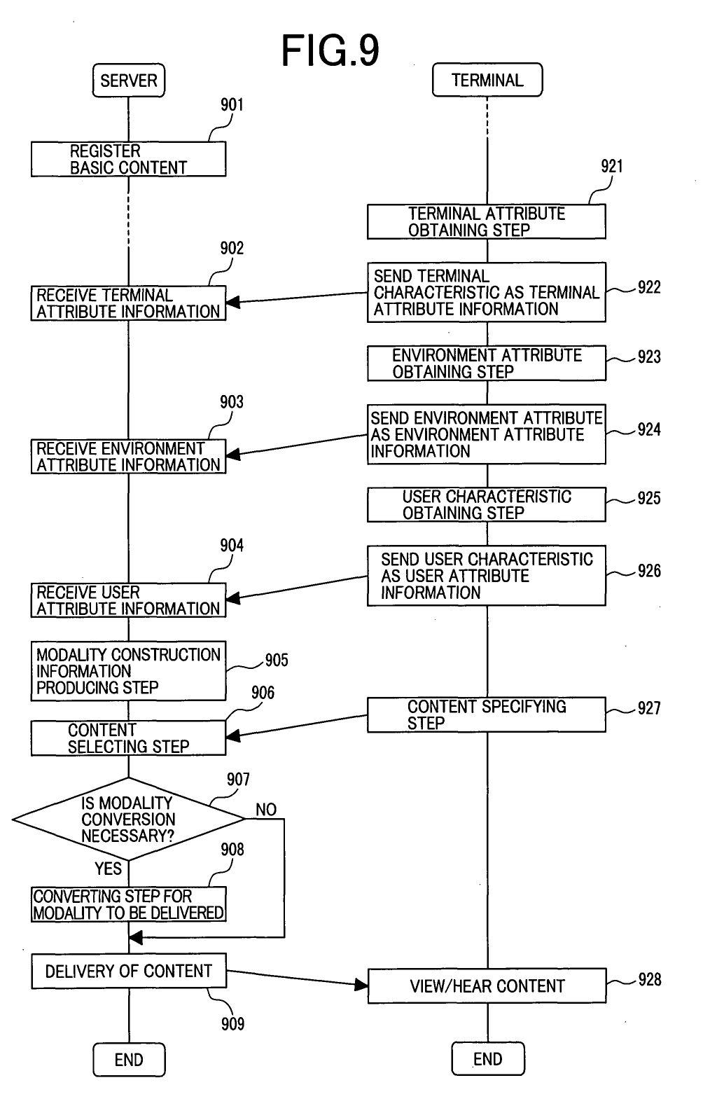

FIG. 9 is a flow chart showing process steps performed at the content delivery server 101 and at the terminal 120. It is assumed that, in the drawing, the notification of the three sets of attribute information, the specification of a content, and the process of content delivery are performed with the same timing at each of the server and the terminal. A description will be given herein below in a temporal order.

First, general-purpose contents termed the basic contents 110 are registered in advance at the content delivery server 101 (Step 901).

On the other hand, the terminal attribute is obtained at the terminal 120 (Step 921). FIG. 10 is a detailed flow chart of the terminal attribute obtaining step (Step 921) as described above.

In the terminal attribute obtaining step, it is examined whether or not video and sound output interfaces for display are present at the terminal in Steps 1001 and 1002 and a modality displayable at the terminal is obtained in Step 1005. A displayable modality is defined herein as, of modalities composing contents delivered from the server (modality constitution for delivery), one which can be decoded properly into a format displayable at the terminal so that it is displayable as a video image or a sound on the output interface unit. If the video interface and the sound interface are present, a modality displayable thereon is added as the terminal attribute (Steps 1003, 1004, and 1006). However, the order in which the attributes are obtained is not limited to that in the present embodiment.

The terminal attributes thus obtained are sent as the terminal attribute information to the server via the input/output unit 122 of the terminal 120 (Step 922) and the content delivery server 101 receives the information via the input/output unit 106 in Step 903. An example of the terminal attribute information thus sent to the server is shown in FIG. 6.

Then, environment attributes are obtained in the sensor unit 125 of the terminal. FIG. 11 is a detailed flow chart showing an example of the environment attribute obtaining step 923.

In this step, data obtained by the sensor unit 125, which may include a plurality of sensor units to be mounted on the terminal 120, and a value obtained by analyzing the data are obtained as environment attributes.

First, each of the usable sensor units 125 is examined (Step 1101) and the name and value of the sensor are obtained (Step 1102) and added as the environment attribute information (Step 1103). The sensor unit 125 has, e.g., generally widely used locational information (information on the latitude and longitude) obtained by a GPS as described above and ambient noise information obtained by a microphone at the terminal. It is also possible to compare the obtained locational information with map data prepared separately at the terminal to provide attribute information indicative of the user aboard a streetcar at the current location. The sensor unit 125 may also obtain network information used by the input/output unit 122 of the terminal 120 to communicate with the input/output unit 106 of the content delivery server 101. In this case, the format, transmission speed, and the like of the network in use can be obtained so that they are used as the environment attributes.

The terminal 120 sends the environment attributes thus obtained to the content delivery server 101 (Step 924 in FIG. 9) and the content delivery server 101 receives the environment attributes (Step 903). An example of the environment attributes thus sent to the content delivery server 101 is shown in FIG. 7.

A description will be given next to the step of obtaining attribute information on the user 121 using the terminal 120.

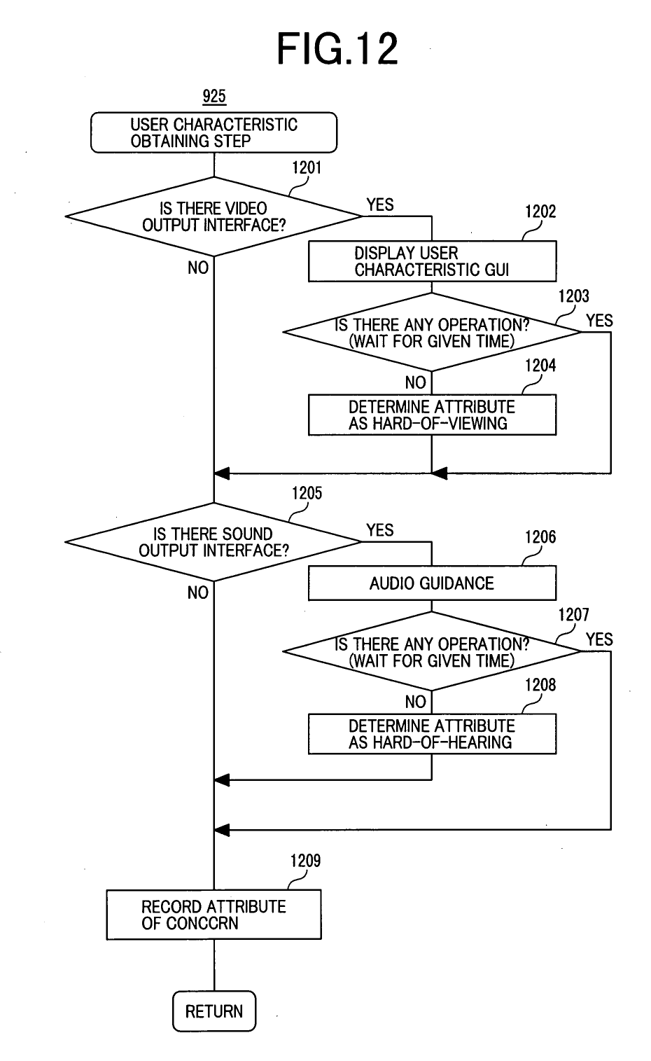

FIG. 12 is a detailed flow chart of the user attribute obtaining step (Step 925 in FIG. 9). The user attribute information may be set automatically or manually by the user. In the case of automatic setting, the foregoing terminal attribute information can also be used.

In the example shown in the flow chart, if there is a video image display interface 131, an instruction to input to the interface is displayed (Steps 1201 and 1202) so that the user responds. If there is no response after an input is awaited for a given time (Steps 1203 and 1204), it is also possible to judge that the user 121 has difficulty in viewing the screen (hard-of-viewing). The same shall apply to the sound interface 132. If an audio guidance is performed (Steps 1205 and 1206) and if there is no reaction thereto (Step 1207), it is also possible to judge that the user 121 has difficulty in hearing (hard-of-hearing) (Step 1208). Thus, the attributes of the user are obtained and recorded (Step 1209).

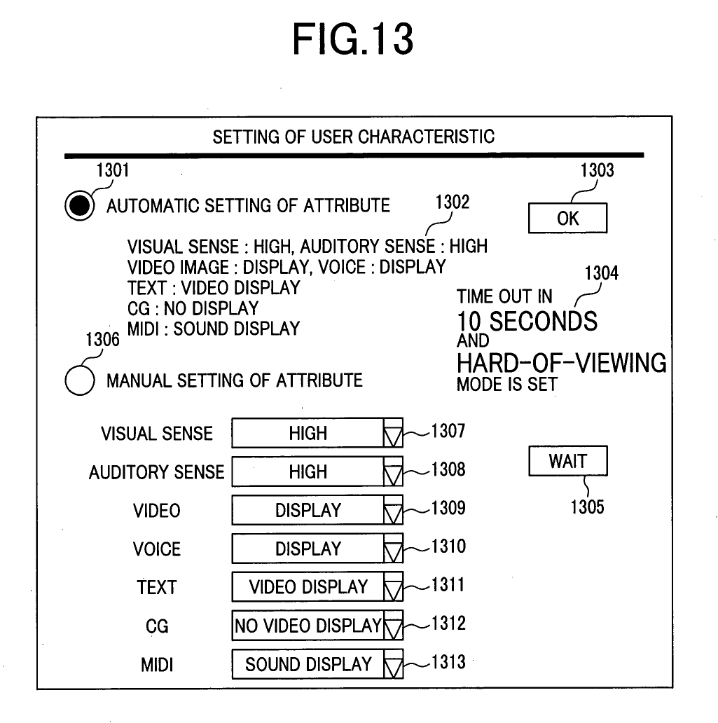

FIG. 13 shows an example of a GUI (Graphical User Interface) for obtaining the user attribute information as described above. In the case of using automatically obtained attribute information 1302 as described above, an automatic setting button 1301 is checked and an OK button 1303 is pressed. If the user 121 has not moved a mouse or pen at all for a given period time, it is possible to judge that the user cannot recognize the display, i.e., is hard-of-viewing, as described above. At this time, the given time (time-out period) is displayed to urge the user to input (1304). Although mere operation is sufficient to cancel the time-out, a button 1305 for halting the time-out can also prepared as a precaution.

It is also possible to manually set the attributes. In this case, a manual setting button 1306 is pressed and then the setting is changed. At this time point, it is judged that the user is not hard-of-viewing and the time-out is cancelled. The attributes to be changed are prepared as a pull-down menu of set items as shown in 1307 to 1313 in the drawing. In addition to the attribute information on the visual and auditory senses, the preference of the user on whether or not a variety of modalities are displayed or whether or not a modality is converted into another mode and displayed may also be set as an attribute.

An example of the user attribute information thus set is shown in FIG. 5, which is sent to the content delivery server 101 (Step 926 in FIG. 9) and received by the server (Step 904), similarly to the other attribute information.

Thus, in Steps 922 to 926, the attributes are obtained in the order of the terminal attribute information, the environment attribute information, and the user attribute information and delivered to the content delivery server 101. This allows the content delivery server 101 to first determine, based on the terminal attribute information, which modalities can be reproduced by using hardware and software possessed by the terminal 120 and then determine, based on the environment attribute information, which modalities can be reproduced depending on the ambient situation of the terminal 120. For example, if the location of the terminal 120 is on a streetcar as described above, a judgment can be made such that the reproduction of a voice or sound is prohibited. Finally, modalities that can be viewed and/or heard by the user 121 can be determined based on the user attribute information.

This allows an optimum modality to be selected in consideration of the ambient environment of the terminal 120 used by the user 121 including the relationship between the user 121 and the terminal 120 and of the situation of the user 121.

The subsequent step in FIG. 9 is a modality construction information producing step (Step 905).

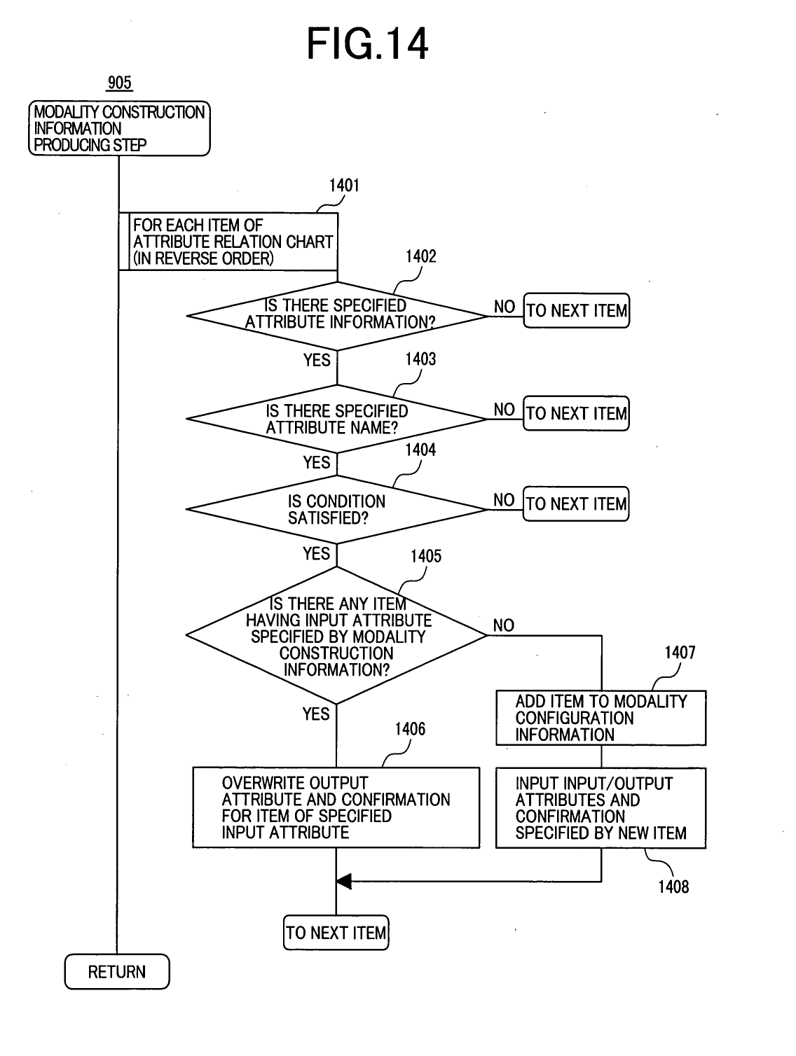

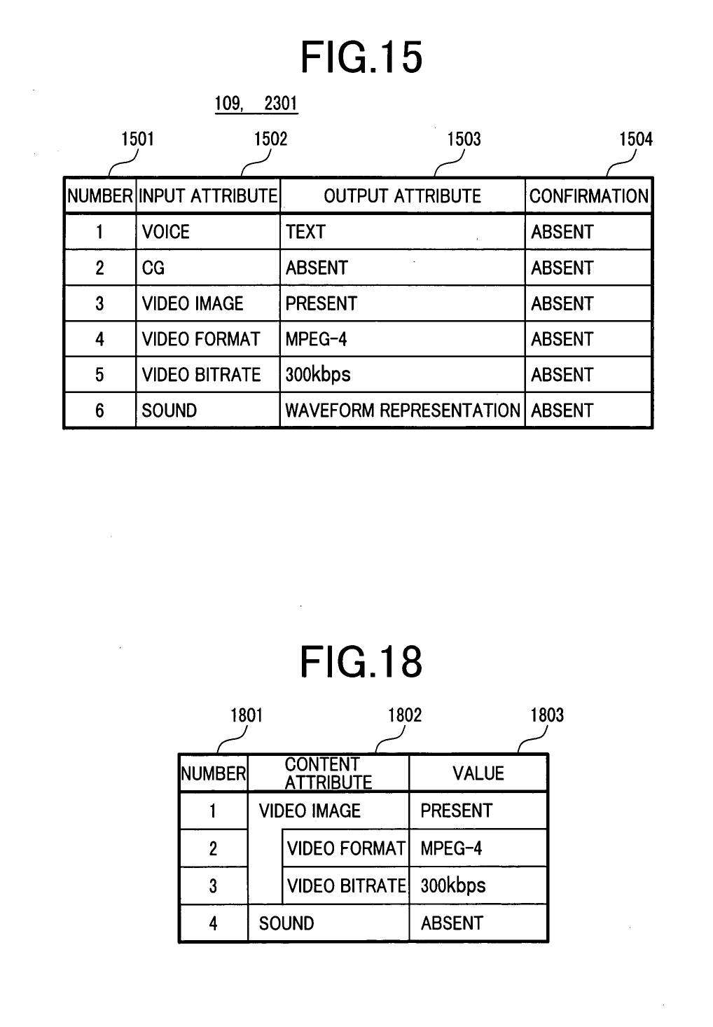

FIG. 14 is a detailed flow chart showing an example of the modality construction information producing step performed in Step 905 of FIG. 9. FIG. 15 shows an example of the modality construction information 109. The modality construction information 109 has a table composed of the items of a number 1501, an input attribute 1502, an output attribute 1503, and a confirmation 1504.

In this step, the modality construction information 109 is produced by using the attribute relation chart 108 as shown in FIG. 8 and any one set (or two sets) of the user attribute information, the terminal attribute information, and the environment attribute information obtained from the terminal 120.

In the modality construction information producing step shown in FIG. 14, each of the items in the attribute relation chart 108 of FIG. 8 is evaluated by performing, in the reverse order, the same operations in a looping manner. If there has already been a similar item, a new content resulting from later evaluation is overwritten (Step 1401). This is because setting is made such that the smaller numbers 801 in FIG. 8 have the higher priorities.

For each of the numbers, it was checked whether or not there is a specified name of attribute information 802 (Step 1402). If there is the specified name of attribute information 802, it is further checked whether or not there is a specified name of attribute 803 (Step 1403). If there is a specified name of attribute 803, the value of the specified attribute is compared with the condition 804 (Step 1404). If the condition is satisfied, it is further checked whether or not there is an input attribute 805 specified by the modality construction information 109. If there is a specified input attribute 805, it was overwritten (updating) so that a higher priority is given (Step 1406) If there isn't a specified input attribute 805, an item is added as new construction information (Step 1407). Irrespective of the presence or absence of the input attribute 805, the output attribute 806 and the confirmation 807 are set and the step advances to the next item in the attribute relation chart.

The process loop is performed with respect to each of the items on the attribute relation chart so that the modality construction information 109 as conditions for a content appropriate for the user 121, the terminal 120, and the environment is produced.

FIG. 15 shows modality construction information produced by using the user attribute information, the terminal attribute information, the environment attribute information, and the attribute relation chart 108 shown in FIGS. 5 to 8.

For example, the terminal 120 does not have the sound interface 132 and the display interface 131 is functioning in FIG. 15 so that a modality in which an input attribute is a voice is converted into a text and outputted. For a modality in which an input attribute is CG, it is set that the output attribute 1503 is absent since the terminal 120 does not have a graphic function which allows reproduction of CG. Since the display interface 131 is functioning and the communication speed is 300 kbps, MPEG-4 is set as a video format. Since the sound interface 132 is absent, waveform representation is set as the output attribute of the sound modal.

The subsequent process in FIG. 9 is the specification of a content. At the terminal 120, a content the delivery of which is requested is specified (Step 927), while the content deliver server 101 inquires the content management unit 104 of the attributes of the content. The content management unit 104 obtains information on the specified content from among the contents recorded in the content DB 107. There may be a plurality of specified contents present, which can be narrowed down through selection made in the subsequent process steps.

As examples of practicing the present invention, two examples in which the subsequent process steps are different, i.e., an example in which modalities composing the content are specified at the content delivery server 101 and an example in which modalities composing the content are converted at the content delivery server 101 will be shown and described individually.

Although the content selecting step (Step 906) and the step of converting a modality to be delivered (Step 908) in the flow chart of FIG. 9 correspond to the two examples, respectively, the foregoing steps may also be used simultaneously (if YES is given as a result of judgment in Step 907).

### FIRST EXAMPLE

Content Selection and Content Reconstitution by Selection of Modality in Content

In the first example, only required modalities are selected from among modalities composing the general-purpose basic contents and the content to be delivered is reconstructed at the content delivery server 101. In this example, the content selecting step (Step 906) is performed after the steps performed thus far in the flow chart of FIG. 9.

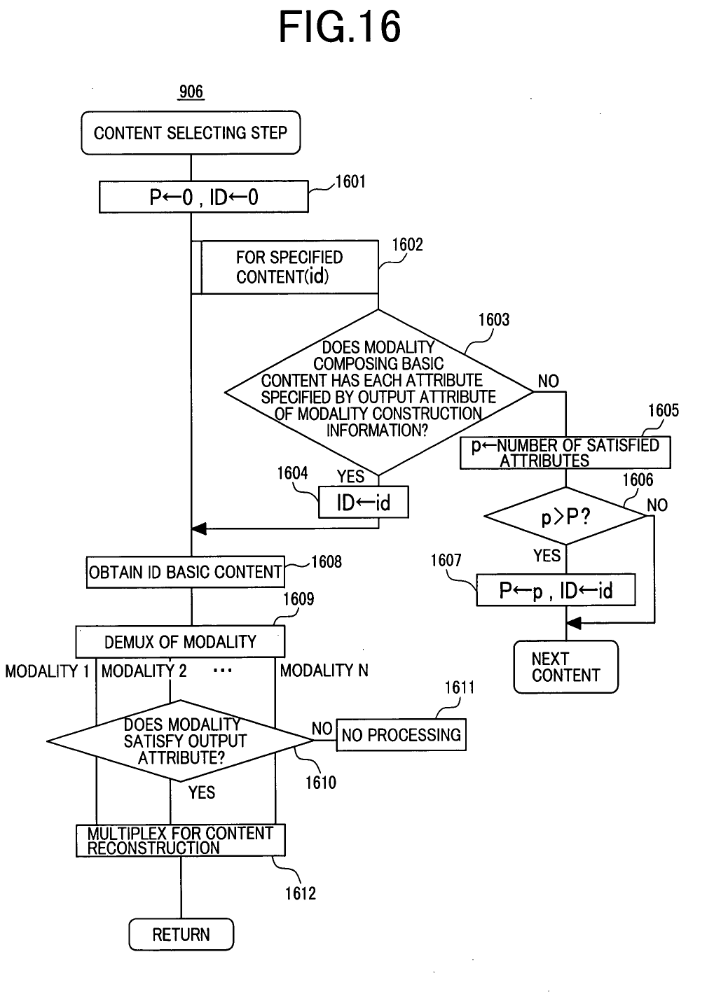

FIG. 16 is a detailed flow chart of the content selecting step performed in Step 906 in FIG. 9.

It was checked whether or not each of the basic contents 110 selected thus far satisfies the attributes indicated by the produced modality construction information 109. First, the value P and the ID are initialized (Step 1601) and then a process loop is performed with respect to the satisfying basic contents to select an optimum basic content.

In the process loop, it is first checked whether or not all the output attributes 1503 indicated by the modality construction information 109 are satisfied by (included in) one of the basic contents (Steps 1602 and 1603). If they are satisfied, the current content number (ID) is recorded (Step 1604) and the process loop is terminated.

If they are not satisfied, the number of the satisfied output attributes 1503 is obtained as the point P (Step 1605). If the point P obtained is the so far highest one, the content ID is updated (Steps 1606 and 1607). After the process loop is terminated for each of the basic contents 110, the optimum content ID is recorded. The content with the ID is obtained (Step 1608) and DEMUX (Demultiplexing) is performed to make division such that processing is performed on a per constituent-modality basis (Step 1609).

Thereafter, only the satisfying modalities are left by referring to the modality constitution information 109 of FIG. 15 produced preliminarily and the subsequent process steps are not performed with respect to the other modalities (Steps 1610 and 1611). To the satisfying modalities, MUX (Multiplexing) is performed such that they are delivered as a content again (Step 1612).

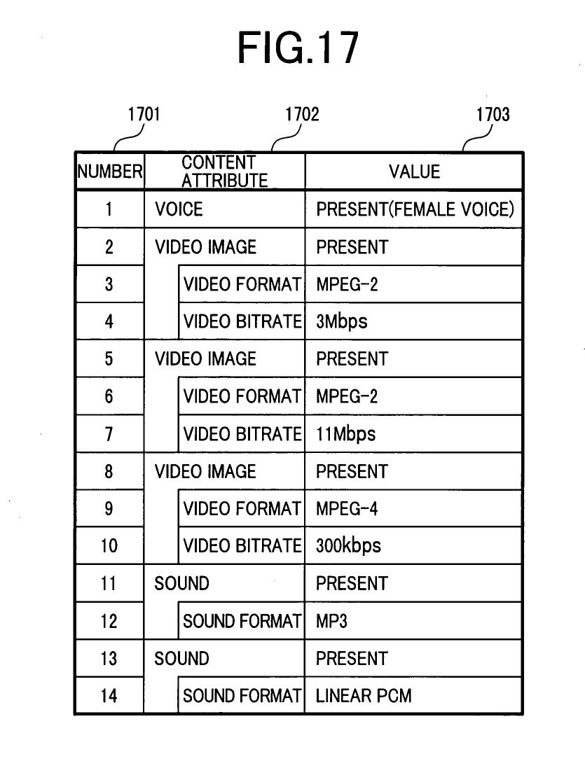

FIG. 17 is a view illustrating the basic content 110 and FIG. 18 is a view illustrating the actually delivered content 116.

The basic content 110 is composed of several modalities. The content shown in the drawing as an example is composed of six modalities consisting of the total of fourteen attributes. In the column of the number 1701 of FIG. 17, each of number groups 2 to 4, 5 to 7, 8 to 10, 11 and 12, and 13 and 14 indicates one modal. The individual modalities are composed of a voice, a video format, video images at different video bit rates, and sounds in different compression formats.

When the foregoing algorithm shown in FIG. 16 is used, the content shown in FIG. 17 is selected. If only the modalities satisfying the modality construction information shown in FIG. 15 are extracted thereafter, the content having the modalities (and the attributes) shown in FIG. 18 is reconstructed.

In FIG. 9, the content 116 to be delivered which has been reconstructed as shown in FIG. 18 is delivered finally to the terminal 120 (Step 909) and reproduced on the output interface at the terminal 120 so that the optimum content is viewed and/or heard by the user 121 (Step 928).

The foregoing process steps allow the content delivery server 101 to select and deliver to deliver a content composed of modalities considering the terminal 120 used by the user 121, the ambient environment including the relationship between the user 121 and the terminal 120, and the characteristics and preferences of the user 121. In short, even if the user 121 changes the location and the terminal 120, he or she can view and/or hear an arbitrary content composed of optimum modalities suited to the environment.

In addition, the content delivery server 101 is also allowed to deliver minimum required data to the terminal 120. By preventing the delivery of modalities that cannot be used at the terminal, as has been performed in the conventional embodiment, a burden on the server and communication equipment can be reduced.

### SECOND EXAMPLE

Content Reconstruction by Conversion of Modalities in Content

In the second example, some of the modalities composing the general-purpose basic content 110 are converted to different modalities at the content delivery server 101 such that they are reconstructed as a new content to be delivered.

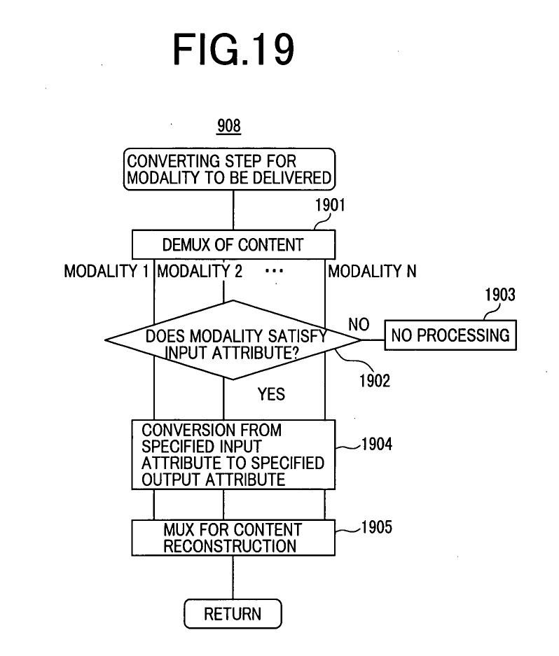

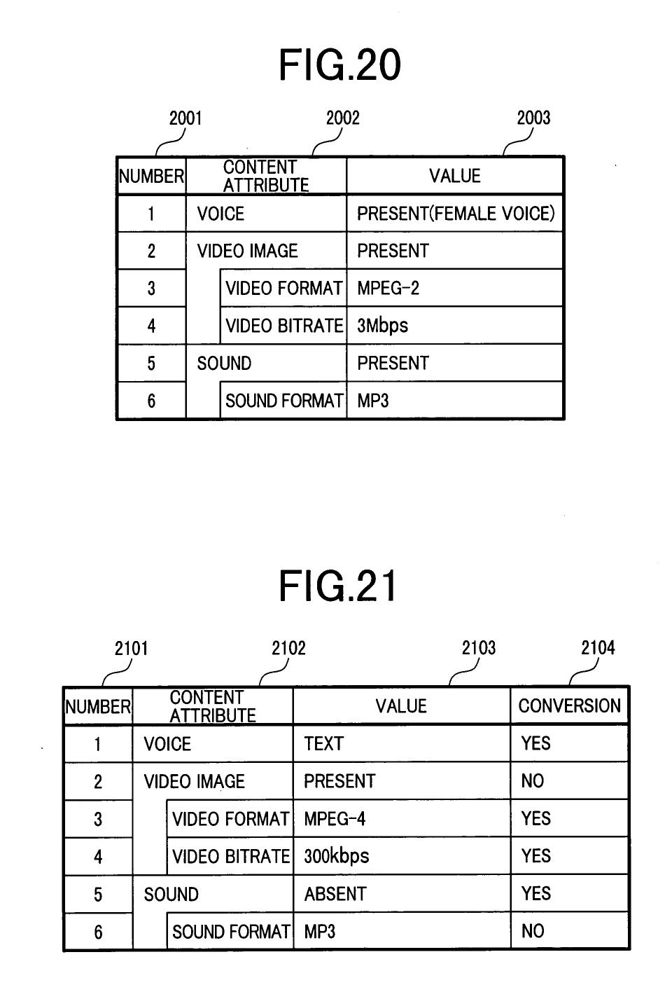

FIG. 19 is a detailed flow chart of the converting step for a modality to be delivered (Step 908) shown in FIG. 9. FIG. 20 is a view illustrating the selected basic content 110.

In FIG. 19, DEMUX (Demultiplexing) is performed first with respect to the basic content 110 so that processing is performed on a per constituent-modality basis (Step 1901). Thereafter, only the modalities satisfying the input attributes 1502 are left by referring to the modality constitution information 109 shown in FIG. 15, which has been produced preliminarily, and the subsequent process steps are not performed with respect to the other modalities (Steps 1902 and 1903).

On the other hand, the satisfying modalities are converted based on the modality construction information 109. At this time, if the attributes of the basic content 110 include one which is the same as the input to the modality construction information 109, the value thereof is changed to the output attribute 1503 of the modality attribute information 109. If there is a change, a flag is provided. If at least one of the modalities is provided with the flag, modality conversion or modality deletion is performed.

FIG. 21 is a view illustrating a design drawing for converting a basic content, which has been thus produced. It will be understood that, in this example, a voice (narration) should be converted to a text (caption) and a video image should be converted from MPEG-2 having a video bit rate of 3 Mbps to MPEG-4 having a video bit rate of 300 kbps. As for a sound (other than the voice), it is eventually deleted from the content without performing any process. An actual conversion method may use a typical well-known modality conversion technology or a plurality of modality conversion technologies in series connection.

Specifically, there are a large number of technologies including conversion based on voice recognition technology for the voice-to-text conversion, e.g., the technology disclosed in JP-A No. 072397/1990 (voice recognition apparatus). For the conversion from MPEG-2 to MPEG-4, it is also possible to temporarily decode MPEG-2 into a bit map and then encode it again into MPEG-4. Conversion from text to voice (narration) may also be implemented by using a typical voice synthesis technology, though it is not used in this example. No more mention will be made herein below since it is well known that a large number of technologies are present for other conversions.

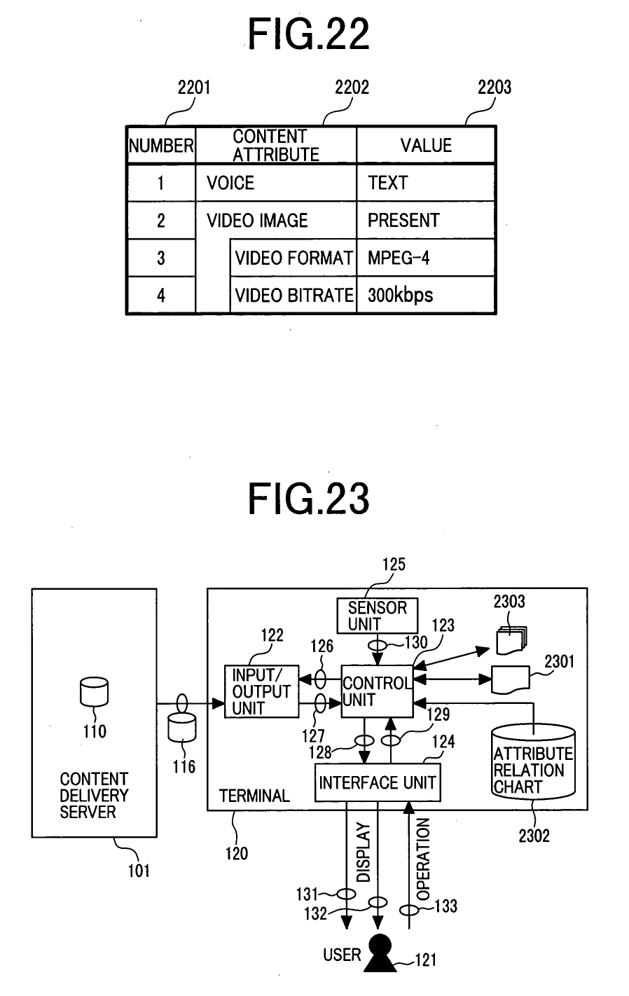

FIG. 22 is a view illustrating the content 116 to be delivered in this example. It can be seen that conversion has been made from the basic content 110 shown in FIG. 20.

Specifically, the voice in the basic content 110 has been converted to a text and the video format of the video image has been converted from MPEG-2 to MPEG-4.

To the modalities resulting from conversion or modalities which need not be converted, MUX (Multiplexing) is performed such that they are delivered again as a content (Step 1905).

In FIG. 9, the content 116 to be delivered thus reconstructed is finally delivered to the terminal (Step 909). The delivered content 116 is reproduced on the output interface at the terminal 120 so that the user views and/or hears the optimal content (Step 928).

Although each of the foregoing first and second examples has described the case where the server performs the process steps by using the three sets of attribute information from the terminal 120, the process steps may also be performed similarly at the terminal 120. As a third example, a description will be given herein below to the case the case where a content is converted at the terminal 120 by using the three sets of attribute information without sending them to the content delivery server 101. Since none of the three sets of attribute information is sent to the server in this case, the leakage of personal information or the like can be circumvented relatively easily.

Thus, according to the second example, the modalities are selected in consideration of the terminal 120 used by the user 121, the ambient environment including the relationship between the user 121 and the terminal 120, and the characteristics and preferences of the user, the content delivery server 101 is allowed to deliver the content obtained by converting some of the modalities of the basic content, and the terminal 120 is allowed to reproduce a content suited to the abilities of the terminal 120 and appropriate for the situation and ambient environment of the user 121.

Since the content delivery server 101 can obtain modalities satisfying the output attribute through conversion provided that only the basic contents 110 are prepared, it is sufficient to produce a content by using the minimum required modalities so that labor and cost required to produce the basic content 110 are reduced.

### THIRD EXAMPLE

FIG. 23 is a view illustrating a system for performing process steps at the terminal.

From the content delivery server 101, the basic contents 110 are delivered as the delivered contents 116 irrespective of whether or not the foregoing first and second examples are used. The terminal 120 is constituted by the control unit 123 located at the center, the input/output unit 122 for performing communication with the content delivery server 101, the interface unit 124 for displaying a content to the user, and the sensor unit 125 for sensing the situation of an external environment. In the present third example, the control unit 123 has an attribute relation chart 2302 used as rules for reconstructing a content suited to the terminal, which will be described later, and modality construction information 2301 generated therefrom. The control unit 123 also manages the user attribute information, the terminal attribute information, and the environment attribute information (2303). The content delivery server 101 is capable of simultaneous connection with a plurality of terminals 120 and operation including communication such as content delivery.

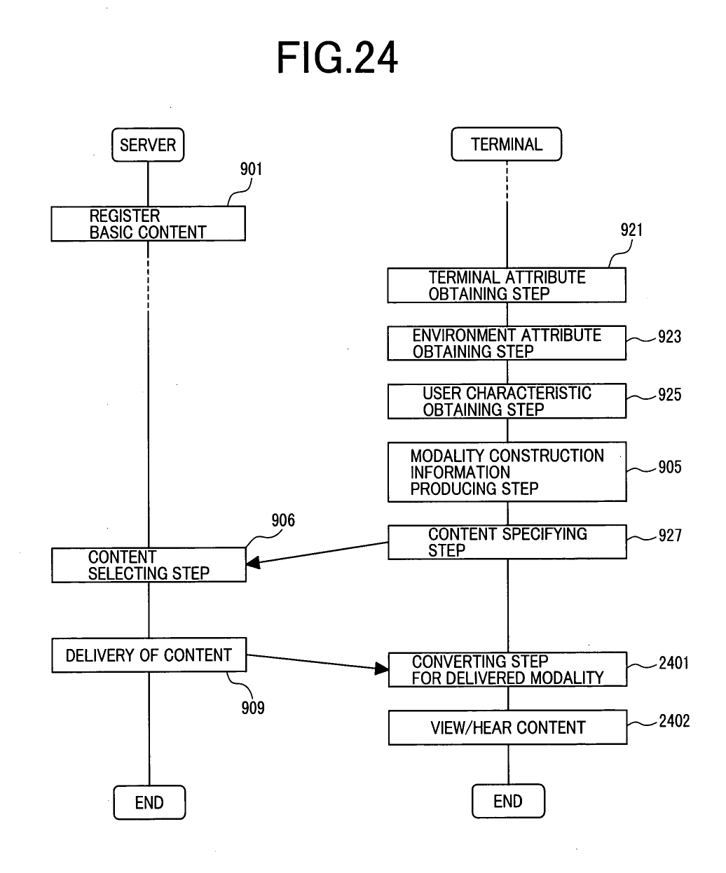

FIG. 24 is a flow chart of operations at the content delivery server 101 and at the terminal 120 in the third example. As for the basic content registration 901, the terminal attribute obtainment (Step 921), the environment attribute obtainment (Step 923), and the user attribute obtainment (Step 925), they are performed in the same manner as in the foregoing first and second examples.

For reference, the detailed process flow charts are shown in FIGS. 10 to 13. The content specification (Step 927), the content selecting step (Step 906) at the content delivery server 101, and the content delivery (Step 909) are also the same as in the foregoing examples.

The difference between the third and the second examples is that the third example performs the modality construction information producing step (Step 905) and the converting step 2416 for a modality to be delivered, which will be described later, at the terminal.

The modality construction information producing step (Step 905) is the same as the step performed in the foregoing example except that it is performed at the terminal 120 in the present example (FIG. 14).

Thus, the same information as shown in FIG. 15 is generated as the modality construction information 2301 at the terminal 120.

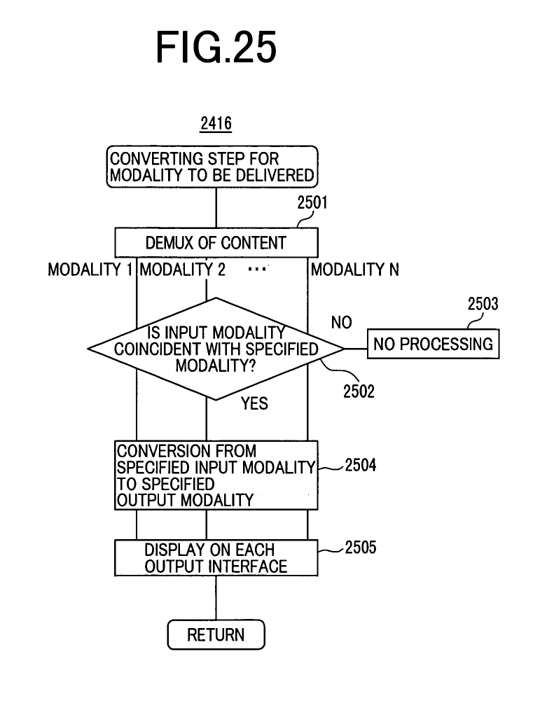

FIG. 25 is a detailed flow chart of the converting step 2416 for a modality to be delivered.

First, DEMUX (demultiplexing) is performed first with respect to a content delivered from the content delivery server 101, as shown in FIG. 20, so that processing is performed on a per constituent-modality basis (Step 2501).

Thereafter, only the modalities satisfying the input attributes are left by referring to the modality constitution information 2301 shown in FIG. 15, which has been produced preliminarily, and the subsequent process steps are not performed with respect to the other modalities (Steps 2502 and 2503). On the other hand, the satisfying modalities are converted based on the modality construction information 2301. At this time, if the attributes of the basic content include one which is the same as the input to the modality construction information, the value thereof is changed to the output attribute of the modality attribute information. If there is a change, a flag is provided. If at least one of the modalities is provided with the flag, modality conversion or modality deletion is performed.

FIG. 21 is a view illustrating a design drawing for converting a basic content, which has been thus produced. It will be understood that, in this example, a voice (narration) should be converted to a text (caption) and a video image should be converted from MPEG-2 having a video bit rate of 3 Mbps to MPEG-4 having a video bit rate of 300 kbps. As for a sound (other than the voice), it is eventually deleted from the content without performing any process. An actual conversion method may use a typical well-known modality conversion technology or a plurality of modality conversion technologies in series connection in the same manner as in the foregoing two examples. The modalities resulting from conversion or a modality which need not be converted are reproduced on the output interface 124 so that an optimum content is viewed and/or heard by the user 121 (Steps 2504 and 2505).

Thus, in the third example, it becomes possible to display to the user 121 a new content produced by selecting some of the modalities composing the contents delivered by the content delivery server 101 in consideration of the terminal 120 used by the user 121, the ambient environment including the relationship between the user 121 and the terminal 120, and the characteristics and preferences of the user 121 without notifying the content delivery server 101 of information on the user 121 and the terminal 120.

In the third example, it is also possible to read, from a network or the like, a program on the reproduction of the content and execute the program.

As shown in these three examples, the use of the present invention allows the user to receive a content composed of modalities suited to the abilities and preferences of the user and appropriate for the terminal used by the user, the time of day, the location, and the ambient situation and view and/or hear the received content in a mode individually effective to the user whenever he or she wants to do so.

Although the foregoing embodiment has described the case where the three sets of terminal attribute information, environment attribute information, and user attribute information are used, it is also possible to use two of the three sets of attribute information. If the two sets of terminal attribute information and user attribute information are used, e.g., modalities to be delivered can be determined based on modalities reproducible at the terminal 120 and on modalities which can be viewed and/or heard by the user 121. In the case of using the two sets of terminal attribute information and environment attribute information otherwise, modalities to be delivered can be determined based on modalities reproducible at the terminal 120 and on modalities which can be viewed and/or heard judging from the ambient situation.

As for which one or ones of the three sets of attribute information consisting of the terminal attribute information, the environment attribute information, and the user attribute information are to be used, it may be determined by the user 121.

Although the example which determines the visual and auditory abilities of the user as the user attribute information by using the GUI and the audio guidance has been shown in FIGS. 12 and 13, the present invention is not limited thereto. For example, it is also possible to display a plurality of languages, record, in the user attribute information, the language to which the user responded as the one understandable by the user, convert the basic content to the language based on the user attribute information, and deliver a content resulting from the conversion. In this case, the use of automatic translation makes it possible to produce a content that can be viewed and/or heard in a large number of languages from a small number of basic contents.

The present invention comprises: an input unit for receiving a content composed of at least one or more modalities; an output interface for reproducing the received modalities; and a control unit for controlling the input unit and the output interface, wherein the control unit obtains, of attribute information composed of terminal attribute information on the output interface, environment attribute information on a current ambient environment of the terminal, and user attribute information on a characteristic of a user using the content by means of the terminal, at least two sets of the attribute information, generates, based on the obtained attribute information sets, modality construction information for specifying modalities to be reproduced, and determines, based on the modality construction information, the modalities to be reproduced at the output interface from among the received modalities. The determination of the modalities to be reproduced is performed by selecting among the received modalities based on the modality construction information.

The present invention comprises: an input unit for receiving a content composed of at least one or more modalities; an output interface for reproducing the received modalities; and a control unit for controlling the input unit and the output interface, wherein the control unit obtains, of attribute information composed of terminal attribute information on the output interface, environment attribute information on a current ambient environment of the terminal, and user attribute information on a characteristic of a user using the content by means of the terminal, at least two sets of the attribute information, generates, based on the obtained attribute information sets, modality construction information for specifying modalities to be reproduced, and determines, based on the modality construction information, the modalities to be reproduced at the output interface from among the received modalities. The determination of the modalities to be reproduced is performed by selecting among the received modalities based on the modality construction information and reconstructing the selected modalities.

The present invention comprises: an input unit for receiving a content composed of at least one or more modalities; an output interface for reproducing the received modalities; and a control unit for controlling the input unit and the output interface, wherein the control unit obtains, of attribute information composed of terminal attribute information on the output interface, environment attribute information on a current ambient environment of the terminal, and user attribute information on a characteristic of a user using the content by means of the terminal, at least two sets of the attribute information, generates, based on the obtained attribute information sets, modality construction information for specifying modalities to be reproduced, and determines, based on the modality construction information, the modalities to be reproduced at the output interface from among the received modalities. The determination of the modalities to be reproduced is performed by selecting among the received modalities based on the modality construction information and converting the selected modalities into different modalities.

The present invention comprises: an input unit for receiving a content composed of at least one or more modalities; an output interface for reproducing the received modalities; and a control unit for controlling the input unit and the output interface, wherein the control unit obtains, of attribute information composed of terminal attribute information on the output interface, environment attribute information on a current ambient environment of the terminal, and user attribute information on a characteristic of a user using the content by means of the terminal, at least two sets of the attribute information, generates, based on the obtained attribute information sets, modality construction information for specifying modalities to be reproduced, and determines, based on the modality construction information, the modalities to be reproduced at the output interface from among the received modalities. Modalities to be delivered to the terminal are determined based on the generated modality construction information and by using the obtained attribute information and an attribute relation chart showing respective priorities of a plurality of attribute elements.

The present invention comprises: an input unit for receiving a content composed of at least one or more modalities; an output interface for reproducing the received modalities; and a control unit for controlling the input unit and the output interface, wherein the control unit obtains, of attribute information composed of terminal attribute information on the output interface, environment attribute information on a current ambient environment of the terminal, and user attribute information on a characteristic of a user using the content by means of the terminal, at least two sets of the attribute information, generates, based on the obtained attribute information sets, modality construction information for specifying modalities to be reproduced, and determines, based on the modality construction information, the modalities to be reproduced at the output interface from among the received modalities. The terminal attribute information includes at least one of presence or absence of a video output unit at the terminal, presence or absence of a voice output unit at the terminal, and a type of a modality displayable on the video output unit or the voice output unit.

The present invention comprises: an input unit for receiving a content composed of at least one or more modalities; an output interface for reproducing the received modalities; and a control unit for controlling the input unit and the output interface, wherein the control unit obtains, of attribute information composed of terminal attribute information on the output interface, environment attribute information on a current ambient environment of the terminal, and user attribute information on a characteristic of a user using the content by means of the terminal, at least two sets of the attribute information, generates, based on the obtained attribute information sets, modality construction information for specifying modalities to be reproduced, and determines, based on the modality construction information, the modalities to be reproduced at the output interface from among the received modalities. The present invention also has a sensor for sensing at least one of a current location of the terminal, a positional relationship between the terminal and the user, a sound characteristic between the terminal and the user, and a video characteristic between the terminal and the user and uses the result of sensing as the environment attribute information.

The present invention comprises: an input unit for receiving a content composed of at least one or more modalities; an output interface for reproducing the received modalities; and a control unit for controlling the input unit and the output interface, wherein the control unit obtains, of attribute information composed of terminal attribute information on the output interface, environment attribute information on a current ambient environment of the terminal, and user attribute information on a characteristic of a user using the content by means of the terminal, at least two sets of the attribute information, generates, based on the obtained attribute information sets, modality construction information for specifying modalities to be reproduced, and determines, based on the modality construction information, the modalities to be reproduced at the output interface from among the received modalities. The user attribute information includes at least one of a visual ability of the user, an auditory ability of the user, and information on the user's preferences to a video image and a sound.

There is provided a program for reproducing, at an output interface, a content composed of one or more modalities, the program causing a computer to perform a reproduction method comprising the step of: obtaining, of attribute information composed of terminal attribute information on an output interface at a terminal, environment attribute information on a current ambient environment of the terminal, and user attribute information on a characteristic of a user using the content by means of the terminal, at least two sets of the attribute information; generating, based on the obtained attribute information sets, modality construction information for specifying modalities to be reproduced at the output interface; determining the received modalities based on the modality construction information; and reproducing the determined modalities at the output interface.

In the foregoing program, modalities to be delivered to the terminal are determined based on the generated modality construction information and by using the obtained attribute information and an attribute relation chart showing respective priorities of a plurality of attribute elements.

1. A content delivery server comprising:
an input/output unit for performing transmission and reception of information between itself and a terminal connected thereto;
a content management unit for managing a content composed of at least one or more modalities; and
a control unit for controlling said input/output unit and the content management unit,
wherein the control unit obtains, of attribute information composed of terminal attribute information on an output interface at the terminal, environment attribute information on a current ambient environment of said terminal, and user attribute information on a characteristic of a user using the content by means of said terminal, at least two sets of the attribute information via said input/output unit,
generates, based on said obtained attribute information sets, modality construction information specifying modalities to be delivered to said terminal,
determines, by using the modality construction information, a modality construction for the content to be delivered, and
delivers said content composed of said determined modalities to said terminal via said input/output unit.

2. The content delivery server of claim 1, wherein said control unit performs the determination of said modalities by selecting, among the modalities composing the content, the modalities of the content corresponding to said modality construction information.

3. The content delivery server of claim 1, wherein said control unit performs the determination of said modalities by selecting among the modalities composing the content based on said modality construction information and reconstructing the selected modalities into said determined modalities.

4. The content delivery server of claim 1, wherein said control unit perform the determination of said modality by selecting among the modalities composing the content based on said modality construction information and converting the selected modalities into different modalities.

5. The content delivery server of claim 1, wherein said control unit determines modalities to be delivered to the terminal based on said generated modality construction information and by using said obtained attribute information and an attribute relation chart showing respective priorities of a plurality of attribute elements recorded thereon.

6. The content delivery server of claim 2, wherein said control unit determines modalities to be delivered to the terminal based on said generated modality construction information and by using said obtained attribute information and an attribute relation chart showing respective priorities of a plurality of attribute elements recorded thereon.

7. The content delivery server of claim 3, wherein said control unit determines modalities to be delivered to the terminal based on said generated modality construction information and by using said obtained attribute information and an attribute relation chart showing respective priorities of a plurality of attribute elements recorded thereon.

8. The content delivery server of claim 1, wherein said terminal attribute information includes at least one of presence or absence of a video output unit at said terminal, presence or absence of a voice output unit at said terminal, and a type of a modality displayable on the video output unit or the voice output unit.

9. The content delivery server of claim 2, wherein said terminal attribute information includes at least one of presence or absence of a video output unit at said terminal, presence or absence of a voice output unit at said terminal, and a type of a modality displayable on the video output unit or the voice output unit.

10. The content delivery server of claim 3, wherein said terminal attribute information includes at least one of presence or absence of a video output unit at said terminal, presence or absence of a voice output unit at said terminal, and a type of a modality displayable on the video output unit or the voice output unit.

11. The content delivery server of claim 1, wherein said environment attribute information includes at least one of a current location of said terminal, a positional relationship between the terminal and the user, a sound characteristic between the terminal and the user, and a video characteristic between the terminal and the user.

12. The content delivery server of claim 2, wherein said environment attribute information includes at least one of a current location of said terminal, a positional relationship between the terminal and the user, a sound characteristic between the terminal and the user, and a video characteristic between the terminal and the user.

13. The content delivery server of claim 3, wherein said environment attribute information includes at least one of a current location of said terminal, a positional relationship between the terminal and the user, a sound characteristic between the terminal and the user, and a video characteristic between the terminal and the user.

14. The content delivery server of claim 1, wherein said user attribute information includes at least one of a visual ability of the user, an auditory ability of the user, and information on the user's preferences to a video image and a sound.

15. The content delivery server of claim 2, wherein said user attribute information includes at least one of a visual ability of the user, an auditory ability of the user, and information on the user's preferences to a video image and a sound.

16. The content delivery server of claim 3, wherein said user attribute information includes at least one of a visual ability of the user, an auditory ability of the user, and information on the user's preferences to a video image and a sound.

17. The content delivery server of claim 1, wherein the control unit generates said modality construction information by preferentially evaluating said terminal attribute information.

18. A content reception terminal comprising:
an input unit for receiving a content composed of at least one or more modalities;
an output interface for reproducing said received modalities; and
a control unit for controlling said input unit and said output interface,
wherein the control unit obtains, of attribute information composed of terminal attribute information on said output interface, environment attribute information on a current ambient environment of said terminal, and user attribute information on a characteristic of a user using the content by means of said terminal, at least two sets of the attribute information,
generates, based on said obtained attribute information sets, modality construction information for specifying modalities to be reproduced, and
determines, based on the modality construction information, the modalities to be reproduced at said output interface from among the received modalities.

19. A program for delivering a content composed of at least one or more modalities to a connected terminal, said program causing a computer to perform a delivery method comprising the steps of:
obtaining, of attribute information composed of terminal attribute information on an output interface at a terminal, environment attribute information on a current ambient environment of said terminal, and user attribute information on a characteristic of a user using the content by means of said terminal, at least two sets of the attribute information via an input/output unit;
generating, based on said obtained attribute information sets, modality construction information for specifying modalities to be delivered to said terminal;
determining, by using the modality construction information, a modality construction for the content to be delivered which is under management of a content management unit; and
delivering said content composed of said determined modalities to said terminal.

20. The program of claim 19, wherein modalities to be delivered to the terminal are determined based on said generated modality construction information and by using said obtained attribute information and an attribute relation chart showing respective priorities of a plurality of attribute elements.
